(19) United States
(12) Patent Application Publication
(10) Pub. No.: US 2009/0312881 A1
(43) Pub. Date: Dec. 17, 2009

(54) SYSTEM AND METHOD FOR CENTRALIZED MONITORING OF DISTRIBUTED POWER TRANSFORMER

(76) Inventors: Luiz Américo Venturini Cheim, Itatiba Sao Paulo (BR); José Geraldo Gervino Silveira, Jundiai Sao Paulo (BR)

Correspondence Address: FAY SHARPE LLP, 1228 Euclid Avenue, 5th Floor, The Halle Building, Cleveland, OH, 44115, US

(21) Appl. No.: 11/993,717

(22) PCT Filed: Dec. 14, 2005
(86) PCT No.: PCT/BR05/00254

§ 371 Date: Jul. 2, 2008

(30) Foreign Application Priority Data
Jun. 21, 2005 (BR) PI0502320-3

(51) Int. Cl. G06F 1/26; G01D 1/00; G06F 15/16; G06Q 10/00; G06Q 50/00; G06N 5/02

(52) U.S. Cl. 700/292; 702/127; 700/297; 709/206; 705/7; 706/46

(57) ABSTRACT

The present invention refers to a system and method for monitoring and controlling the operational condition of a power transformer. The system for monitoring and controlling the operational condition of a power transformer comprised at different substations comprises a plurality of substations, each substation comprising a control panel linked to at least one power transformer, said control panel receives data referring to the measurements of parameters of said at least one transformer, and a monitoring center comprising an engineering server, an internet server and software that does the communication of said engineering server to said internet server, said engineering server being in communication with control panels of each of the substations and said internet server provides remote access to the system to the users of the system. The method of the present invention comprises the steps of (a) continuously measuring parameters of a plurality of power transformers comprised at a plurality of substations; and (b) storing the data referring to the measurements performed in step (a) at a database only when said measurements are not within a range of values that were previously determined as desirable for the measurements of said parameters; and (c) making the measurements of the parameters performed in step (a) available at one single physical location. The invention further provides a monitoring center that allows the follow up of the condition of operation of several power transformers located at several substations.

This application claims priority of brazilin patent case No. PI0502320-3 filed on Jun. 21, 2005 which is hereby incorporated by reference.

The present invention refers to a system and method for centralized monitoring and controlling the operational condition of power transformers which are able to detect failures in the operation of said transformers. The invention further refers to a power transformer monitoring center that allows a general and a centralized follow up of the operation of several transformers, which may be comprised at different substations.

### DESCRIPTION OF THE STATE OF THE ART

The systems for monitoring and controlling the operational condition of a power transformer of the state of the art usually show the following architecture: a power transformer linked to a central control and data processing station, which, by its turn, is linked to an intranet environment. The transform generally is provided with sensors that continuously detect measurements of parameters such as winding temperature, oil level, voltage, room temperature, tap, gases in oil, etc. The data referring to the measurements of these parameters may be accessed, followed, adjusted and monitored by a user through the intranet. The data are continuously stored at a database at the control substation.

The system disclosed above requires the database of the control substation to have a great storage capacity, because all the measurements detected by the sensors of the transformer are stored. Even though some of these measurements are not relevant, all of them are stored, and, consequently, fill the database with information that is little useful. Thus, the database of the system is slowly becomes overloaded, slowing the system down.

Besides overloading the system, the continuous storage of all the data many times leads to a false diagnosis of the operational condition of the transformer. When the system detects an increase or decrease in the measurement of a parameter, it issues an alarm indicating the occurrence of a failure in the operation of the transformer. However, many times, these alarms are false, that is, they indicate a failure or a problem that in fact does not exist. The user may, for example, adjust a determined parameter for a different value of the one usually used for the transformer to operate at a specific condition during a determined time in order to comply with a specific demand. This minor adjustment may generate an expected variation in some other parameter. However, as the systems of the state of the art are not able to correlate these data, they issue a “false” alarm that the transformer is showing some problem, even though there is no problem in the operational condition of the transformer. These false alarms generate wrong diagnosis of the operational condition of the transformer. The person in charge of monitoring the transformer may be lead to believe that the transformer is showing a problem and take determined actions to solve the supposed problem without it existing in fact. The performance of determined procedures to overcome these supposed problems may, occasionally, generate actual failures in the system and harm or compromise the running of the transformer.

Further to the drawbacks disclosed above, none of the systems available nowadays allows the follow up and the centralized monitoring of transformers of different substations. The substations usually comprise more than one transformer which are geographically distant among themselves. The monitoring of the transformers of these substations is presently made in an individual basis, that is, the systems commercially available do not allow that all transformers at all substations are monitored at one single physical location. Thus, companies are forced to have several teams for monitoring of each one of the substations. It is desirable therefore to create a system and a method for monitoring transformers that is centralized and that allows global control of all transformers at all substations.

The system and method for monitoring and controlling the operational condition of power transformers proposed by the present invention come to overcome the above drawbacks and improve and ease the monitoring and control of the operational condition of transformers. Furthermore, the invention proposes a system and a method that allow the centralization of the process of following up or monitoring power transformers at different substations.

### OBJECTIVES OF THE INVENTION

The present invention aims at providing a system for monitoring and controlling the operational condition of a power transformer which is able to detect actual and mostly initial failures that may occur during the operation and running of a transformer, and, thus, give time for a user to act and correct said failure.

The present invention is further aimed at providing a system for monitoring and controlling the operational condition of power transformers that continuously detects the measurements of parameters of the transformers, identifies when these measurements differ from values that were previously established as desirable for said parameters and stores this data at a database.

A third objective of the present invention consists in providing a system for monitoring and controlling the operational condition of a power transformer able to correlate data stored at a database in such a way as to avoid the emission of an alarm that suggests a failure or problem in the transformer that, in fact, does not exist. The alarms generated by systems to indicate a problem or failure in the operation or running of a transformer that, in fact, does not exist will be called herein below, false alarms.

The invention is further aimed at providing a system for monitoring and controlling the operational condition of a power transformer that may be accessed by a user anywhere in the world, preferably by means if an internet environment.

Another objective of the invention rests in providing a system for monitoring and controlling the operational condition of a transformer that comprises intelligent computational means that estimate the financial return generated due to the operation and running of a power transformer.

The invention is further aimed at providing a method for monitoring and controlling the operational condition of a transformer that continuously measures parameters of an electrical transformer and stores the data referring to the measurements only when said measurements are not within the range of values that were previously determined as desirable for the measurements of the respective parameters (intelligent storage).

The invention is further aimed at providing intelligent computational means that estimate the financial return generated due to the operation and running of a power transformer and that may be employed in different systems for monitoring and controlling the operational condition of a power transformer.

The invention is further aimed at providing a system and method for monitoring and controlling the operational condition of a power transformers that show an intelligent way for the acquisition and storage of data referring to the operation and running of the transformers.

Another objective of the invention consists in providing a system and a method for centralized monitoring and controlling of the operational condition of power transformers located at different substations, these substations being geographically apart.

It is a further objective of the present invention to provide a monitoring center of power transformers at several substations, in order to make a global follow up of the running of all transformers at all substations possible at one single physical location.

### BRIEF DESCRIPTION OF THE INVENTION

The objectives of the present invention are reached by means of a system for monitoring and controlling the operational condition of power transformers comprised at different substations that comprises a plurality of substations, each substation comprising a control panel linked to at least one power transformer, said control panel receives data referring to the measurements of parameters of said at least one transformer, and a monitoring center comprising an engineering server, an internet server and software that does the communication of said engineering server to said internet server, said engineering server being in communication with control panels of each of the substations and said internet server provides remote access to the system to the users of the system.

The invention additionally provides a method of the present invention that comprises the steps of: (a) continuously measuring parameters of a plurality of power transformers comprised at a plurality of substations; and (b) storing the data referring to the measurements performed in step (a) at a database only when said measurements are not within a range of values that were previously determined as desirable for the measurements of said parameters; and (c) making the measurements of the parameters performed in step (a) available at one single physical location.

The invention further provides a monitoring center of power transformers at a plurality of substations that comprises (i) an engineering server; (ii) an internet server; (iii) software that does the communication between the engineering server and the internet server, the engineering server communicating to the control panels of said plurality of substations and the internet server makes the data monitored from the transformer available at an intranet/internet environment.

### BRIEF DESCRIPTION OF THE DRAWINGS

The present invention will be, as follows, described in more detail based on an embodiment represented in the drawings. The figures show:

FIG. 1—illustrates the general architecture of the system for centralized monitoring and controlling the operational condition of power transformers of the present invention;

FIGS. 2-13—illustrate several screenshots comprised in the system of the present invention showing different steps of the method for monitoring and controlling the operational condition of a power transformer of the present invention;

FIG. 14—illustrates a graph of the curves of a technical standard (in this case, ABNT—Brazilian Association of Technical Standards) relating the time of life expectancy (in years) of a transformer to the continuous Hot-Spot temperature (in ° C.).

FIG. 15—illustrates a monitoring center where all information and data referring to the monitoring of power transformers at different substations located at different regions is available.

### DETAILED DESCRIPTION OF THE INVENTION

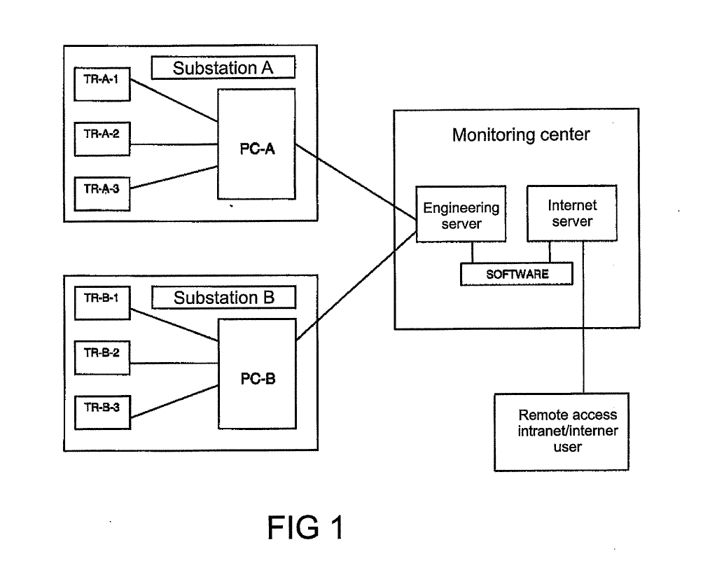

FIG. 1 illustrates a preferred general architecture of the system for monitoring and controlling the operational condition of power transformers of the present invention. As illustrated in this figure, the system comprises a plurality of substations A and B, which comprise power transformers TR-A-1, TR-A-2, TR-A-3 and TR-B-1, TR-B-2 and TR-B-3 and control panels PC-A and PC-B. All transformers comprise sensors (not shown) that detect the measurements of the parameters to be measured in the transformers, such as winding temperature, gas in oil, oil humidity, voltage etc. The data detected at these sensors are digitalized and subsequently transmitted to the control panels PC-A and PC-B. The control panels communicate with the engineering server of the monitoring center.

The engineering server is responsible for all intelligence of the systems and receives, stores, correlates and analyses the data referring to the measurements of the parameters of the transformers. In order to obtain a continuous follow up and a more efficient monitoring of the power transformers of the substations, the parameters of the transformers are continuously measured and detected.

The monitoring center further comprises an internet server for providing remote access to the system to registered and authorized users to access the system. The data stored at the engineering server remain available at the internet server. The use of two different machines (engineering server and internet server) for the performance of two different activities is extremely important for the system optimization. The engineering server is totally responsible for the system intelligence and, therefore, will be responsible for receiving, storing, correlating and analyzing the data referring to the parameters of the transformers. The engineering server is further responsible for the emission of a diagnosis of the operational condition of the transformers, by the emission of alerts indicating the occurrence of a failure in the transformers (when applicable), indication of an action to be taken to solve eventual failures detected and emission of a prognosis of what may happen if the indicated action to solve the failure is not carried out. By the other hand, the internet server that is all the time in communication with the engineering server aims at making this information available for the system users and at providing remote access to the system to these users via intranet/internet.

An important aspect of the present invention consists in allowing the global follow up of a plurality of transformers that are found at a plurality of substations geographically apart among themselves at a single physical location (monitoring center—see FIGS. 1 and 15).

From the monitoring center, users have access to the system and may follow up the measurements of the parameters of the transformers and determine/adjust ranges of desirable values for each one of these parameters. The determination of these ranges of desirable values is of great importance as it allows the system to take determined values as base for the monitoring and to be able to identify the occurrence of undesired variations in the parameters of the transformers. In order for the running and operation of the transformers to be optimized it is necessary that the parameters thereof show values within a specific range. The ranges of these values will be determined according to the criteria considered adequate by the companies which own the transformers and may vary.

The engineering server comprises a database that stores the data referring to the measurements of the parameters of the transformers only when the measurements of the parameters differ from a range of values previously defines as desirable. Hence, if the measurements detected by sensors are not within the range of values defined as desirable for said parameter, the measurements will be stored at the database of the engineering server. If, on the other hand, the measured values are within the range of values determined as appropriate, these data will not be stored. That prevents the database from filled with data with little relevance and optimizes the running of the system.

Some parameters may show small variations, however such variations may be relatively expected during the operation of a transformer, and, therefore, may not disclose or suggest any type of failure or problem in the transformer. However, it is important to have some kind of record of these variations, even though it should not be excessive.

Thus, the system displays previously defined storage ranges and failure ranges. The storage range determines a range of expected values for a determined parameter and determines a minimal delta that the detected variation should have in order to be stored. By its turn, the failure range determines a range of values that may be considered as indicative of a failure. For example, if a desired value for a determined parameter is 50 mu (measurement unity), the system may establish that values that show a minimal delta of 1 mu may be stored and values that show a minimal delta of 2 mu must be considered as indicative of an eventual failure. Hence, when the system detects 51 mu, this value will be stored, but will not indicate and neither will suggest any kind of failure in the system. However, when the system detects 52 mu, this value will be stored at the database and will indicate a possible failure in the transformer. However, the system will not issue any kind of alarm when the value of 52 is detected. Before issuing an alert, the engineering server of the system will correlate this variation with the remaining measured values and analyze if that variation in fact indicates or not some kind of failure in the transformer.

Thus, when the measured value of a parameter is not comprised within the range previously determined as desirable (storage range) and, further, fits within the range of values that may be considered as indicative of failure (failure range), the systems performs a correlation with the remaining measurements in order to identify if the variation happened due to the establishment of a new range of values for another parameter or if such variation is due to a specific situation at a determined moment. With the correlation of these information and data, the system itself can evaluate if in fact there is any failure or problem in the transformer. If the analysis performed by the system and, more specifically, by the engineering server, does not identify any failure, no alarm will be issued. The emission of false alarms is thus prevented.

On the other hand, if the system identifies any failure or problem in the transformer, the system will generate a diagnosis of the operational condition and, if applicable, suggest a recommended action and indicate the consequences that may happen if the recommended action is not taken.

One of the main aspects of the present invention consists, therefore, in the fact that only some of the measurements of the parameters of the transformers are stored at the database. Thus, the database is less full of information and the utilization of the system becomes faster and quicker. The intelligence of the systems allows an optimization in the data acquisition and storage.

The engineering server of the system for monitoring and controlling of the operational condition of a power transformer of the present invention further comprises a data processing and management module of the data stored at the database. This module will be responsible for the correlation of the stored data by the evaluation of the correlation between said stored data and by the generation of a diagnosis of the operational condition of the transformer. If applicable, the processing and management module will suggest a recommended action to solve the failure or problem of the transformer and will indicate the consequences that may happen if the recommended action is not taken.

Another important aspect of the invention lies in the fact that all stored data may serve to generate a history of the behavior and of the operational conditions of a power transformer during a determined period of time. From the information stored at the database reports may be generated with this history, allowing a user to have a general view of the operation of a transformer.

The user interface and the control station must, preferably, be developed in an internet environment, in such a way as to allow a user to have remote access to the monitoring and controlling system of the invention. Working on an internet environment, the access and follow up of the operation of a transformer is possible from anywhere in the world. All information, data, alarms and diagnosis remain available in the intranet/internet of the user.

The parameters of the transformer which are continuously measured refer to at least one among winding temperature, oil level, voltage, room temperature, tap, gases in oil, oil humidity, air flow, oil upper/lower temperatures and insulation conditions. Any other parameters may be measured and are not limited to those exemplified above.

The invention also devises the possibility of the engineering server to comprise an electronic mail device that sends an e-mail to a user when a failure in the operational condition of the transformer is detected. The companies define which persons must receive the alert e-mails. The sending of e-mails makes the follow-up and monitoring of the transformers and of the substation as a whole easier. With the sending of alert e-mails, the person in charge of the monitoring is not required to check all the time if any failure happened in the system. That reduces, therefore, the need for a large number of people to monitor all transformers of all substations. Thus, companies may have a reduction in the number of people for the performance of this function (monitoring of the transformers) and reduce costs.

The e-mail sent to the person in charge of monitoring the transformers indicates an internet address that must be accessed to verify the problem. Several people may be registered in the system to receive the alert e-mails. However, as soon as one of the registered user accesses the internet site indicated in the alert e-mail, a new e-mail is sent to the other registered users informing that the problem is being verified by the user that accessed the site. Thus, all registered users are notified that a failure is taking place in the system and that a determined user is arranging the solution for said failure.

The system further devises the use of an international protocol that interlinks the engineering server and the internet server and allows them to communicate with other supervisory systems, for example, of the SCADA type.

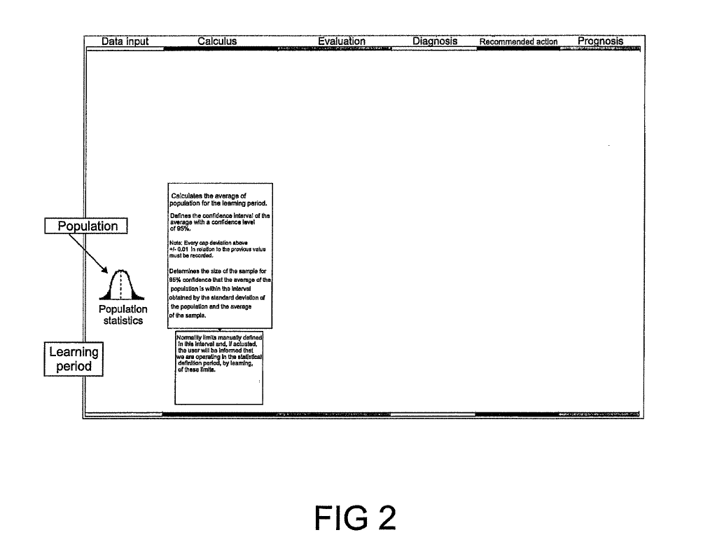

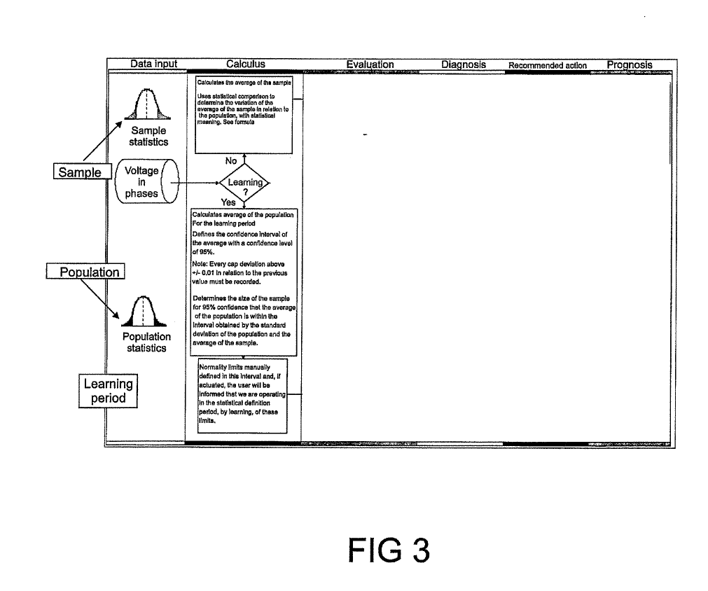

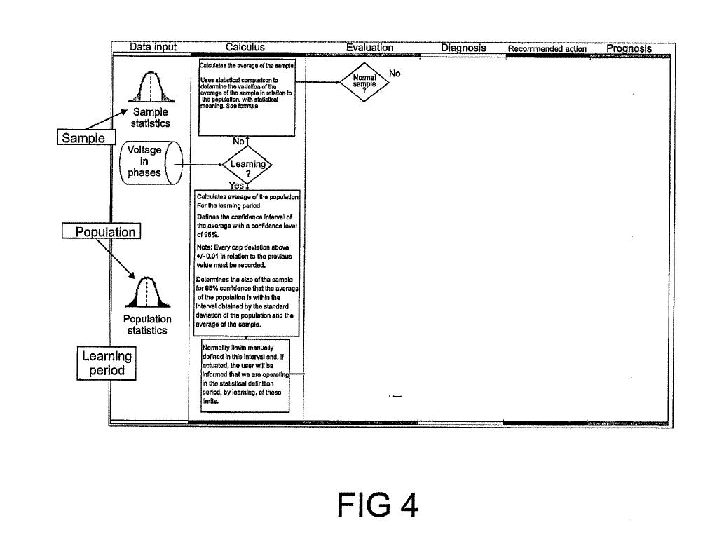

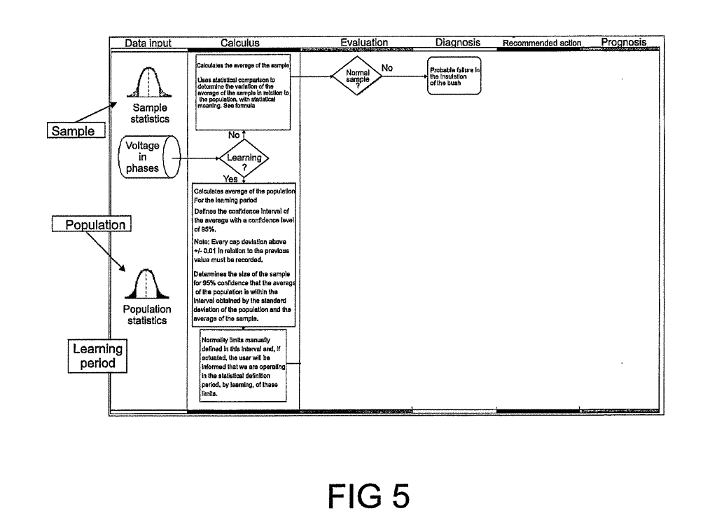

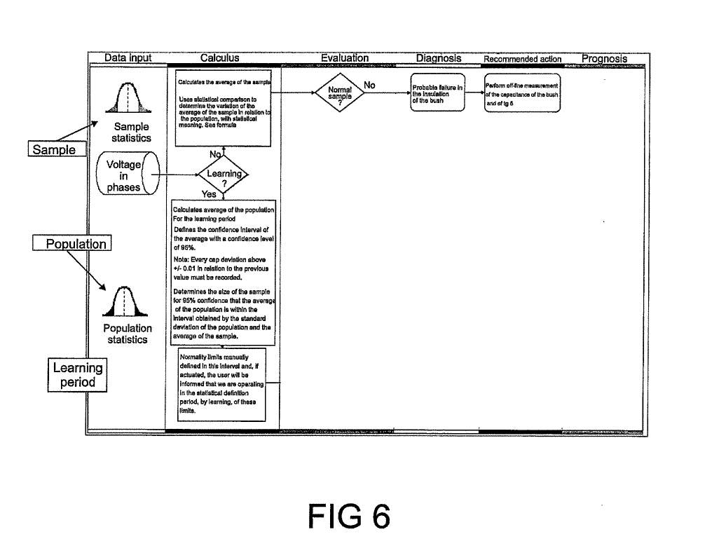

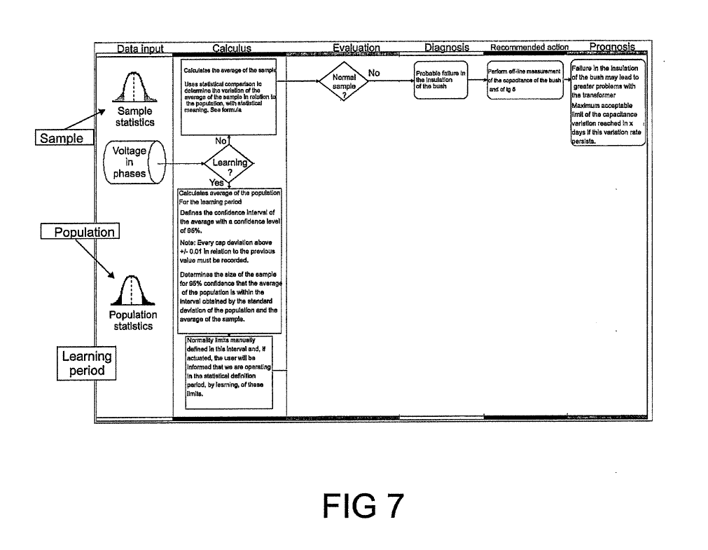

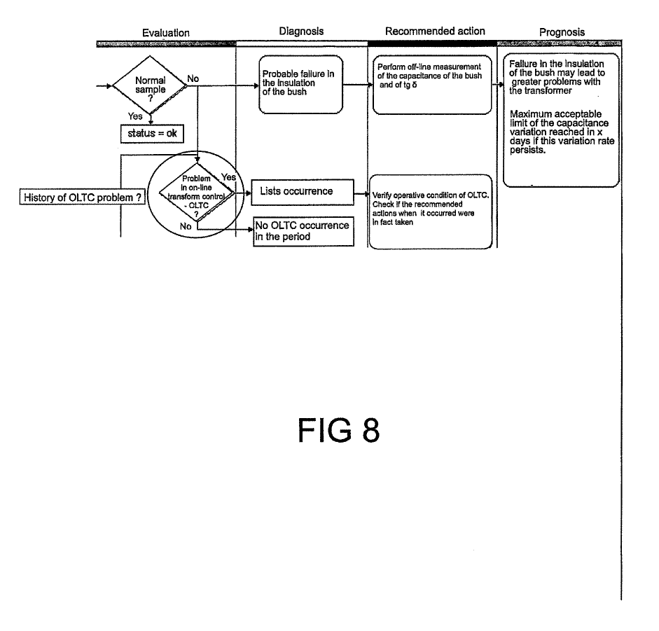

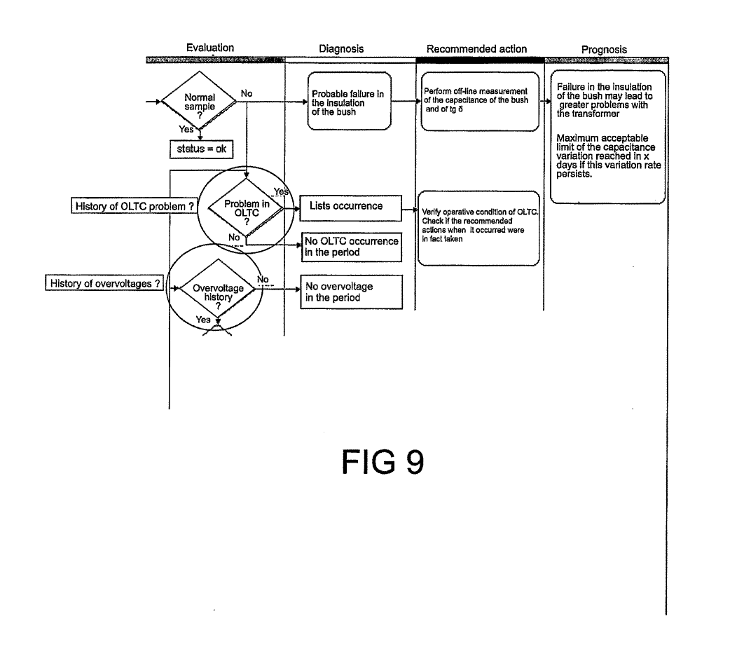

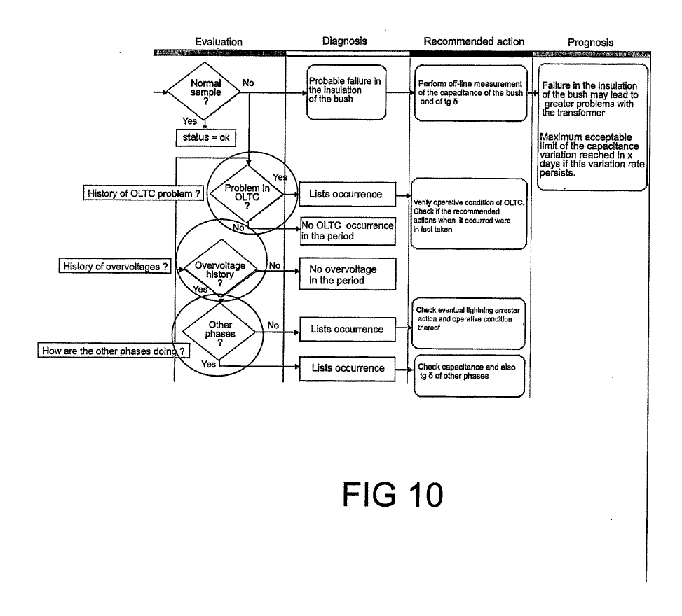

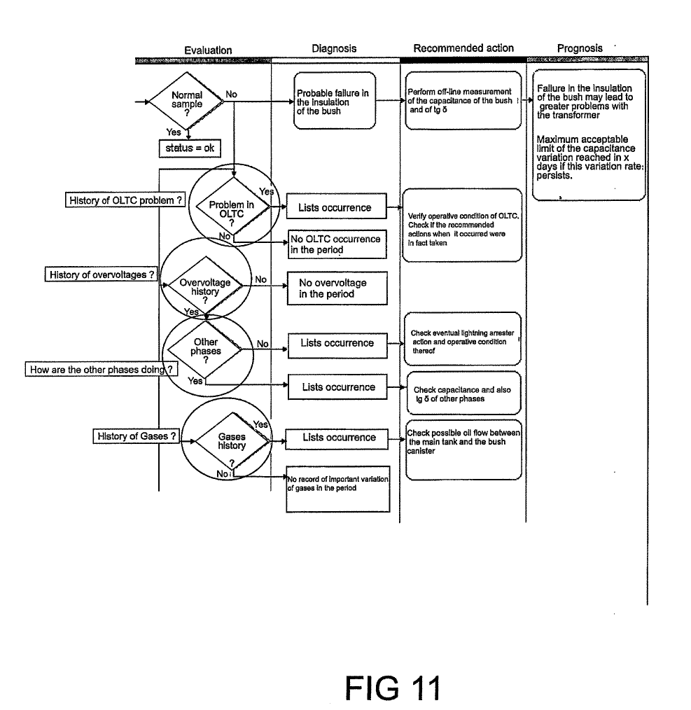

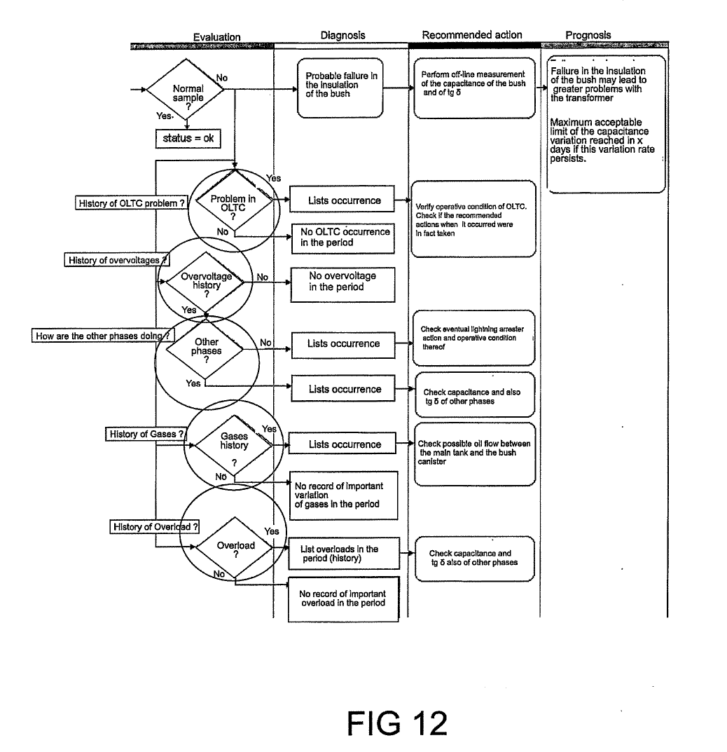

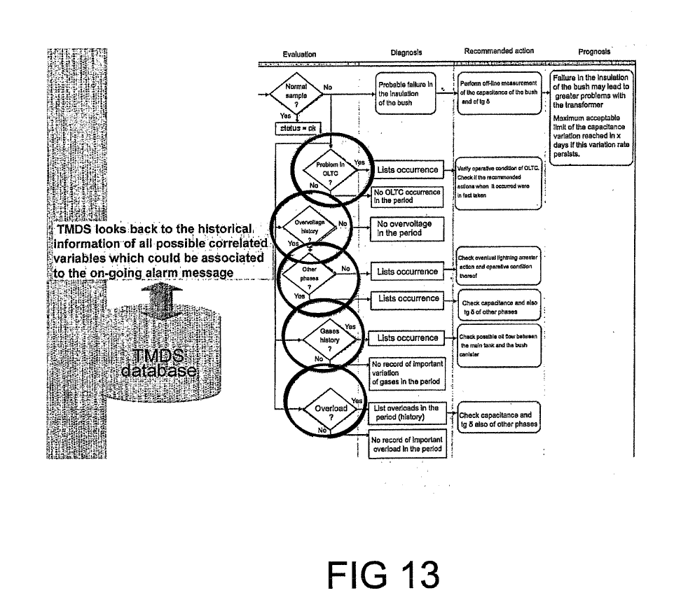

Referring to FIGS. 2 to 13, there are illustrated screenshots exemplifying the system for monitoring and controlling the operational condition of a transformer, showing step by step the steps of data input, calculus, evaluation, diagnosis, recommended action and prognosis.

The system of the present invention optionally comprises computational means (for example, software) that generates an analysis of the financial return from the use of the transformer or for the calculation of the economic profitability of power transformers using a mathematical equation.

The computational means represent a technical-economical model that is based on the fundamental issue regarding the life expectancy of a transformer. According to Brazilian (ABNT) and international (IEEE-ANSI/USA—The Institute of Electrical and Electronics Engineers, Incorporated/American National Standards Institute, IEC—International Engineering Consortium and other countries of the world) technical standards, it can be understood that the life expectancy of a transformer is associated to the equivalent operation temperature at the hot spot that is monitored. For example, if a transformer operates at 95° C. at the hot spot, it is expected to last 35 to 40 years, depending on the standard. If it is wanted that a transformer lasts 40 years, according to ABNT, the transformer will have to operate with an equivalent temperature of 95° C. Although it may seem simple, this analysis is very complex, principally because the temperature at the hot spot of the transformer is not continuously monitored and, in general, it is not known what this equivalent temperature would be along 5 or 10 years of operation, even because this temperature varies cyclically with load (for example, the load in summer is different from the load in winter) and with the room temperature itself.

Under a financial point of view, it must be further analyzed what is the economic impact associated to the type of operation to which the transformer is subjected. For example, in Brazil, ANEEL (National Agency of Electrical Energy) determines that the transformer must last 40 years. The electric power utility company must perform an investment to acquire the transformer, keep it along these forty years, depreciate the invested capital, pay interest over the loan made to acquire the asset, run an operational risk (for example, of not meeting the demand in case of failure of the equipment) and, additionally, have some kind of financial return for the fact of meeting the power demand when it installs the transformer at some substation or electrical power plant.

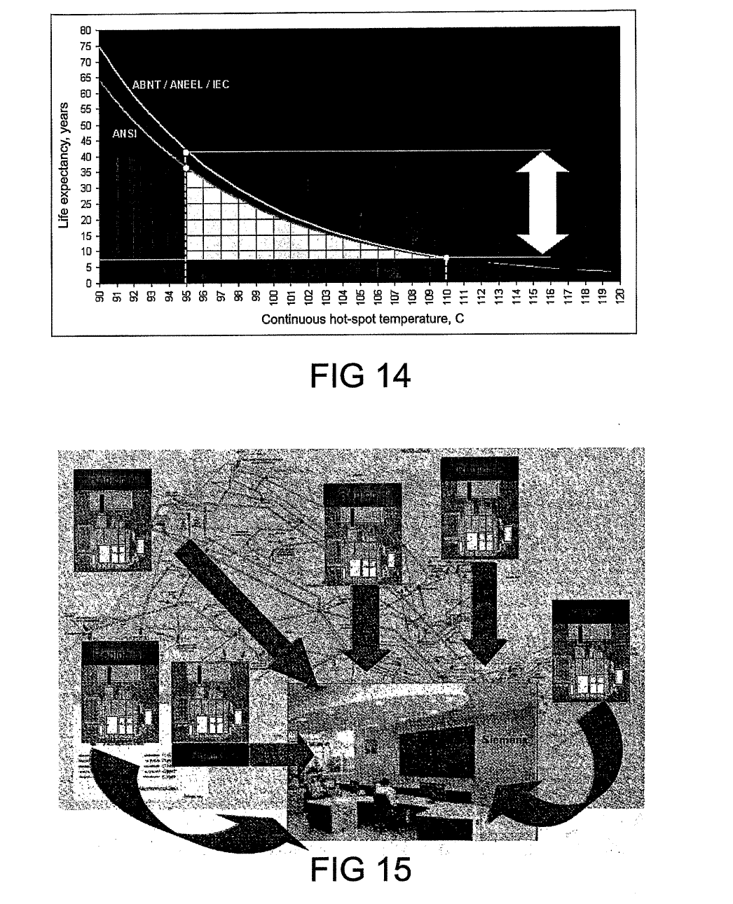

This technical-economical model mentioned aims at associating all these parameters, including life expectancy of the equipment, the financial return that the company would have if the equipment lasted 40 years or 10 years, for example. All this, based on the simple accounting equation shown as follows, in the curves of the standard illustrated in FIG. 14 relating the depreciation time (or equipment life), to the costs involve din the acquisition/operation thereof and of meeting the demand for power.

Result=Revenue−TOC (Total Ownership Cost)

Where:

TOC=annual depreciation+annual maintenance cost+annual insurance cost+opportunity cost+monetary devaluation cost+failure risk.

Revenue=net remuneration by meeting the demand of power×load factor of the transformer (how much percent of the nominal capacity is used to meet the demand, limited to the value that leads to the life expectancy calculated as per the curves of the standard shown in FIG. 15)×monetary correction factor×factor of transformer use (how long of the 24 h×365 days of the year the transformer, in average, is kept in fact energized)×efficiency of the transformer (part of the power that the transformer receives is lost internally so that it operates adequately and gives to at the other end the desired level of voltage, at the desired power)+net remuneration by meeting the power demand×load factor of the transformer (how much percent of the nominal capacity is used to meet the demand, limited to the value that leads to the life expectancy calculated as per the curves of the standard shown in FIG. 15)×monetary correction factor×factor of transformer use (how long of the 24 h×365 days of the year the transformer, in average, keeps in fact energized)×efficiency of the transformer (part of the power that the transformer receives is lost internally so that it operates adequately and gives to at the other end the desired level of voltage, at the desired power)×factor of overload remuneration (how much more the power utility company receives by meeting the peaks of electrical power demand, above the nominal conditions of the equipment)×average time of overload in the year.

Failure risk=failure cost×probability of failure (Eq. 1)

Probability=1−reliability (Eq. 2)

Reliability=e^{-λ×t} (Eq. 3

Risk=failure cost×(1−e^{-λ×t}) (Eq. 4)

Where:

λ=average accumulated rate of failure of the transformers (typically of about 1.5 to 3% per year).

t=time of operation in years.

Failure cost:

a) Conservative: cost of replacing the failed transformer by a new one;

b) Aggressive: same as item a) obeying costs of not meeting the demand and to the costs involved in the acquisition/operation of the equipment.

The failure cost is defined as an annual “cost”, associated to the failure probability that also grows annually in this model, even considering a failure rate constant to the power utility company (factor A in the expression above).

The annual cost is then defined by the failure probably (1−reliability)×failure cost, which conservatively is considered the same as the cost of replacing a failed unity by a new one. All this is considered year by year.

The present mathematical model demonstrates that not always the higher financial return happens when the life time of the transformer is of about 40 years, as ABNT suggests. In some cases, the model demonstrates that it is more advantageous under an economical and financial point of view to operate the transformer with a higher load for a shorter period of time (for example, of about 15 years). The mathematical model brings innovative results, surprising in relation to the best way of operating a transformer to achieve the highest financial return.

The present invention further provides a method for the centralized monitoring and controlling the operational condition of power transformers comprised at different power substations comprising the steps of: (a) continuously measuring parameters of a plurality of power transformers comprised at a plurality of substations; (b) storing the data referring to the performed measurements in step (a) at a database only when said measurements are not within a range of values previously defined as desirable for the measurements of said parameters; and (c) make the measurements of the parameters performed in step (a) available at one single physical location.

The method further comprises the steps of (d) correlating said stored data at the database; (e) evaluating the correlation made between said stored data; (f) generating a diagnosis of the operational condition of the transformers based on the evaluation made in step (e) and, if applicable, suggesting a recommended action and indicating the consequences that may happen if the recommended action is not taken.

Preferably, the method is carried out by the system for centralized monitoring and controlling of the operational condition of power transformers of the present invention.

Optionally, the method further comprises the step of sending an e-mail to one or more users when a failure in the operational condition of one of the transformers of the substations is detected. The alert e-mail indicates an internet address (website) that must be accessed by the user in order to verify the problem. The invention further provides a monitoring center of power transformers of a plurality of substations that comprises (i) an engineering server; (ii) an internet server; (iii) software that does the communication between the engineering server and the internet server, the engineering server communicating to the control panels of said plurality of substations and the internet server makes the data monitored from the transformer available at an intranet/internet environment.

The follow up and the monitoring of the operational condition of all transformers at different substations at one single physical location optimizes the process of monitoring and maintenance of the transformer, reducing, thus, the costs, involved in these processes.

The term “engineering server” used along all specification is commonly used in the field of the invention and must be understood as an intelligent server, such as a data control and processing station.

Furthermore, it is important to be understood that the user may, remotely, adjust and establish new ranges of desirable values for the parameters of a transformer according to different criteria.

A preferred embodiment having been disclosed, it must be understood that the scope of the present invention encompasses other possible variations, being limited only by the content of the appended claims, possible equivalents also included.

1. System for centralized monitoring and controlling the operational condition of power transformers comprised at different substations, the system comprising:
a monitoring center comprising an engineering server, an internet server and software that does the communication of said engineering server to said internet server, said engineering server being in communication with control panels of each of the substations and said internet server provides remote access to the system to the users of the system,
a plurality of substations, each substation comprising a control panel linked to at least one power transformer, said control panel receives data referring to the measurements of parameters of said at least one transformer,
wherein the data referring to the measurements of parameters of said at least one power transformers are only stored in said engineering server when the measurements of the parameters differ from a range of parameters values previously defined as desirable.

2. System according to claim 1, wherein said engineering server comprises a database for storing the data referring to the measurements of parameters of the power transformers at the substations and a data processing and managing module of the data stored at said database.

3. System according to claim 2, wherein the data processing and managing module of the data stored at the database correlates the stored data, evaluates the correlation among said stored data and generates a diagnosis of the condition of operation of the transformer and, if applicable, suggests a recommended action and indicates the consequences that may happen if the recommended action is not taken.

4. System according to claim 1, wherein one of the parameters of the transformer refers to at least one among winding temperature, oil level, voltage, room temperature, tap, gases in oil, oil humidity, air flow, oil upper/lower temperatures and insulation conditions.

5. System according to claim 1, wherein the engineering server is developed at internet environment.

6. System according to claim 1, further comprising software for the analysis of the financial return proceeding from the use of the transformer using the following mathematical equation: Failure risk=failure cost×probability of failure (Eq. 1).

7. System according to claim 1 wherein the engineering server further comprises an electronic mail device that sends an e-mail to a user when a failure in the operational condition of some of the transformers at the substations is detected.

8. Method for centralized monitoring and controlling the operational condition of power transformers comprised at different substations, said method comprising the steps of:
a) continuously measuring parameters of a plurality of power transformers comprised at a plurality of substations; and
(b) storing the data referring to the measurements performed in step (a) at a database only when said measurements are not within a range of values that were previously determined as desirable for the measurements of said parameters; and
(c) making the measurements of the parameters performed in step (a) available at one single physical location.

9. Method according to claim 8, further comprising the steps of:
(d) correlating said data stored at the database;
(e) evaluating the correlation made among said stored data;
(f) generating a diagnosis of the operational condition of the transformers based on the evaluation made in step (e) and, if applicable, suggesting a recommended action and indicating the consequences that may occur if the recommended action is not taken.

10. Method according to claim 8 wherein said method is performed by a system for centralized monitoring and controlling the operational condition of power transformers comprised at different substations, the system comprising:
a monitoring center comprising an engineering server, an internet server and software that does the communication of said engineering server to said internet server, said engineering server being in communication with control panels of each of the substations and said internet server provides remote access to the system to the users of the system,
a plurality of substations, each substation comprising a control panel linked to at least one power transformer, said control panel receives data referring to the measurements of parameters of said at least one transformer,
wherein the data referring to the measurements of parameters of said at least one power transformers are only stored in said engineering server when the measurements of the parameters differ from a range of parameters values previously defined as desirable.

11. Method according to claim 8, further comprising the step of sending an e-mail to a user when a failure in the operational condition of one of the transformers is detected.

12. System according to claim 2, wherein one of the parameters of the transformer refers to at least one among winding temperature, oil level, voltage, room temperature, tap, gases in oil, oil humidity, air flow, oil upper/lower temperatures and insulation conditions.

13. System according to claim 3, wherein one of the parameters of the transformer refers to at least one among winding temperature, oil level, voltage, room temperature, tap, gases in oil, oil humidity, air flow, oil upper/lower temperatures and insulation conditions.

14. System according to claim 2, wherein the engineering server is developed at internet environment.

15. System according to claim 3, wherein the engineering server is developed at internet environment.

16. System according to claim 4, wherein the engineering server is developed at internet environment.

17. System according to claim 2, further comprising software for the analysis of the financial return proceeding from the use of the transformer using the following mathematical equation: Failure risk=failure cost×probability of failure (Eq. 1).

18. System according to claim 3, further comprising software for the analysis of the financial return proceeding from the use of the transformer using the following mathematical equation: Failure risk=failure cost×probability of failure (Eq. 1).

19. System according to claim 4, further comprising software for the analysis of the financial return proceeding from the use of the transformer using the following mathematical equation: Failure risk=failure cost×probability of failure (Eq. 1).

20. System according to claim 5, further comprising software for the analysis of the financial return proceeding from the use of the transformer using the following mathematical equation: Failure risk=failure cost×probability of failure (Eq. 1).
